(19) United States
(12) Patent Application Publication
(10) Pub. No.: US 2016/0237662 A1
(43) Pub. Date: Aug. 18, 2016

(54) FAUCET CONTROL VALVE

(71) Applicant: Chia-Po Chang, Changhua (TW)

(72) Inventor: Chia-Po Chang, Changhua (TW)

(73) Assignee: HAIN YO ENTERPRISES CO., LTD., Changhua (TW)

(21) Appl. No.: 14/622,811

(22) Filed: Feb. 13, 2015

(51) Int. Cl. E03C 1/04; F16K 27/04; F16K 11/065

(52) U.S. Cl. CPC E03C 1/04; F16K 11/0655; F16K 27/04; E03C 2001/026

(57) ABSTRACT

A control valve includes a valve body and a valve seat, which is fixed at a bottom of the valve body, and has a roof with a spout thereon. Both side edges at front of the spout have intervals including a water inlet duct. The lateral arcs of the two inlet ducts are designed to taper the inlet duct. Also the upper sides of two inlet ducts connect with the roof, and the relative position on the roof of each duct has a limber hole to let water down into the inlet ducts. The two inlet ducts are used as an entry which penetrates the lateral arc to let each cold and hot water through into the ducts. An annular pad is outside of cold and hot water inlets to cover the ducts. The two intervals, which locate on the backsides of outlet, extend a ladder-shaped positioning pin respectively.

### FIELD OF THE INVENTION

The present invention relates to a structure of the control valve of faucet for controlling the flow opening and closing, or changing the mixing ratio of hot and cold water and the amount of water.

### BACK GROUND OF THE INVENTION

The current faucet (as shown in FIGS. 9 and 10) is mostly installed control valve (40) in the faucet body (30) to control the flow opening and closing, change the mixing ration of hot and cold water and the amount of water. The faucet body (30) includes a compartment (31) which is reserved during casting process. The vertical partitions (32) are located under the compartment. The purpose of vertical partition is that separating the inlets which flow into the faucet body to cold water inlet duct (33) and hot water inlet duct (34) and each inlet set a limber hole (35) on the compartment to let water flow into compartment. The two sides on the back of faucet body connect with the cold water inlet (36) and the hot water inlet (37) respectively to let hot and cold water flow into the faucet. The cold water inlet (36) joint with the cold water inlet duct (33) to connect water source and the hot water inlet duct (34) is set on the other side and connect to the hot water inlet (37). The limit holes (311) are settled on the bottom of compartment for fixing the positioning pin of control valve (40). On the backside of compartment has an outlet hole (312) to connect to the drain pipe (38) of faucet body. The hot water and cold water flow into compartment respectively from limber holes of hot and cold water inlet on the bottom of compartment. The mixing ration of cold and hot water can be controlled by control valve (40) and the mixed water flow out from the outlet hole (312) of faucet body (30) to drain pipe (38). The positioning pins (125) are set extending from the bottom of control valve (40). By embedded positioning pins into limit holes (311), the inlet of cold and hot water on the control valve can be connect more precisely to the limber holes (35) and outlet hole (312) in the faucet body (30).

However, conventional structure described above still has some problems to apply to the practical application and there are some concerns below: (i) the design of faucet body (30) is limited by the cold and hot water inlet and outlet hole which are on the bottom of control valve (40). It needs to set vertical partitions (32) and let water flow up into the limber holes (35) on compartment (31) to separate cold and hot water effectively. However, the installation of vertical partitions (32) in the faucet body (30) makes flow channels in the body become more complex. So that the faucet body (30) will be more difficult to be cast and the defect rate will rise; (ii) when cold and hot water fill into the control valve (40), they will flow into the cold water inlet duct (33) and hot water inlet duct (34) respectively, and let waters flow up into the limber holes (35) reach control valve (40). This multi-stage bending design will increase cold and hot water flow noise during the water transport, and smoothness of water flow will be greatly reduced; and (iii) after install the control valve (40) in compartment (31), the sealing collars which cover periphery of the compartment will be difficult to adhere to internal wall of compartment (31). Under such circumstances, the device will not be reliable and cause leaking easily.

Therefore, there remains a need for a new and improved design for a faucet control valve to overcome the problems presented above.

### SUMMARY OF THE INVENTION

According to the problems that we mentioning above, the design of conventional faucet body is limited by the cold and hot water inlet and outlet hole which are on the bottom of control valve. It needs to set vertical partitions (32) and let water flow up into the limber holes (35) on compartment (31) to separate cold and hot water effectively However, the installation of vertical partitions in the faucet body (30) makes flow channels in the body become more complex.

The present invention provides a structure of faucet which has a control valve, including a valve body and a valve seat, coordinating with a faucet in use. The valve body has a valve casting, and a valve stem and two pieces of valve discs are installed in the valve casting. The use of valve stem provides an operating system to make two valve discs aligned or misaligned so that controlling the switch or change the mixing ration of cold water and hot water. The lower edge of valve casting has a connecting hole to provide the hook of valve seat fix on the notch. The valve seat, has a roof, is fixed under the valve body. A spout is set on the roof, and the both side edges at front of the spout have intervals and set up the inlet ducts which lead water down. The lateral arcs of two inlet ducts are designed as arc which narrows down to the tapered shape. The both bottoms are all closed. Also the upper sides of two inlet ducts connect with a roof and the relative position on roof of each duct has a limber hole to let water down into the inlet ducts. The two inlet ducts are used an entry which penetrate the lateral arc to let each cold and hot water through into the ducts. The outside of cold and hot water inlets set annular pad to cover the ducts. The two intervals, which locate on the backsides of outlet, each extend downward a ladder-shaped positioning pin respectively. The faucet body is formed integrally and the internal of body set up the division chamber and control valve chamber which are connect up and down with each other. The division chamber include a tapered inwall which narrows from up to down. Above the control valve chamber has an opening for penetration, the bottom of control valve chamber is connected to the division chamber by stepped convex ring. The both edges of backside of the faucet body have cold water inlet and hot water inlet. The cold water inlet connects with the cold water inlet duct which is on the one internal side of the faucet body and the hot water inlet connects with hot water inlet duct which is on the other internal side of the faucet body. The two inlet ducts directly connect to the horizontal perforations of division chamber respectively. By connecting the outlet duct of the faucet body to the front outlet of the division chamber, the cold water and hot water not only can flow individually but also can be mixed when they flow through the outlet duct and come out from outlet. The bottom of division chamber has limit holes for helping the positioning pins of control valve fix on division chamber.

Comparing with conventional faucet control valves, the present invention is advantageous because (i) by installing the inlet ducts combines with the cold and hot water inlets which are penetrated horizontally, the faucet control valve in the present invention can separate cold water and hot water in the faucet body without installing the vertical partitions. In other words, the present invention can simplify the complexity of the internal flow channel, so that the faucet body can be easier to manufacture and has significantly improved the yield of casting; (ii) the design of letting water horizontally penetrate through cold and hot water inlet can lead two kind of water into control valve without passing the multi-stage bending segments. This invention can effectively reduce water flow noise during the water transport and make cold and hot water flow more smoothly; and (iii) the design of tapered lateral arc can make control valve more fit with division chamber when put control valve into division chamber. This invention can successful prevent leak of water and make the system becomes more reliable.

### BRIEF DESCRIPTION OF THE DRAWINGS

FIG. 1 is a three-dimensional, exploded view of the control valve of the present invention.

FIG. 2 is a plain view of the control valve of the present invention.

FIG. 3 is an A-A sectional view of FIG. 2 of the present invention.

FIG. 4 is a plain view from another angle of the control valve in the present invention.

FIG. 5 is a B-B sectional view of FIG. 4 in the present invention.

FIG. 6 is a schematic view of the faucet body with control valve in use in the present invention.

FIG. 7 is sectional view of the present invention used with a faucet.

FIG. 8 is another sectional view of the present invention used with a faucet.

FIG. 9 is a prior art.

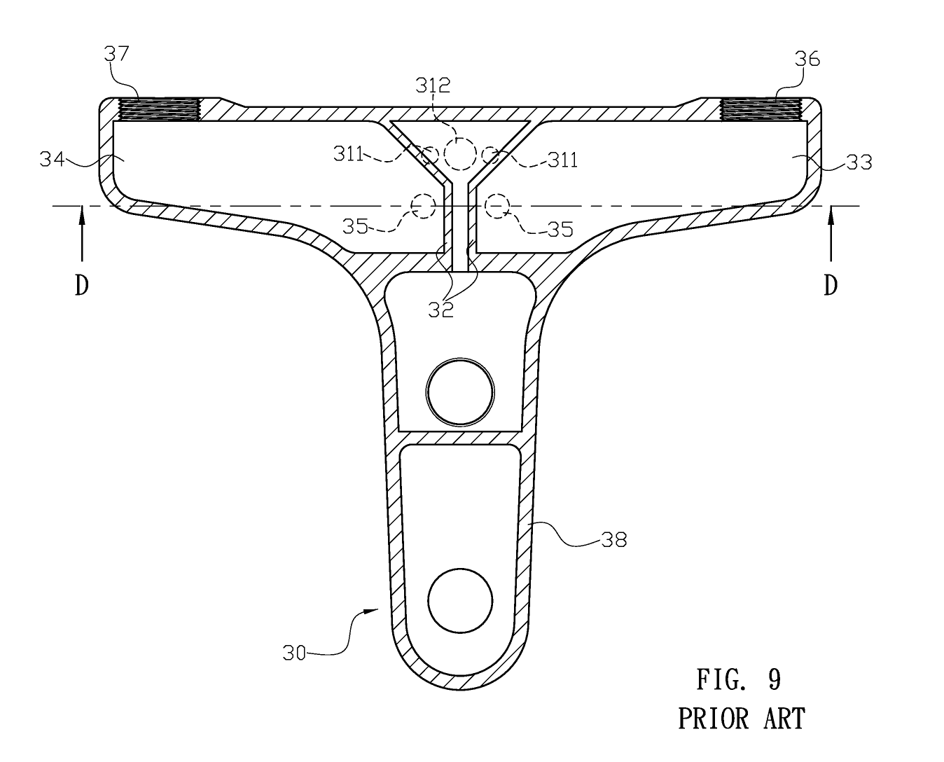

FIG. 10 is a prior art in use.

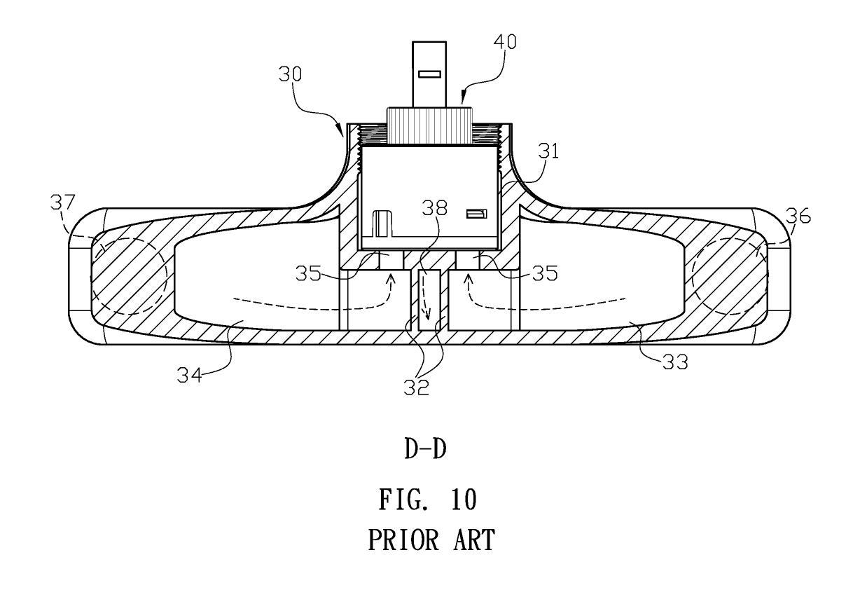

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

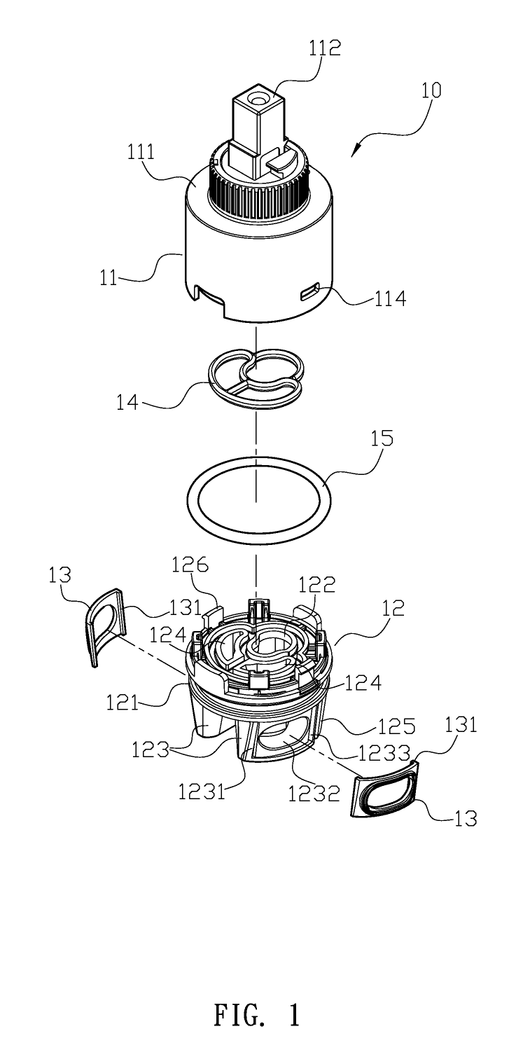

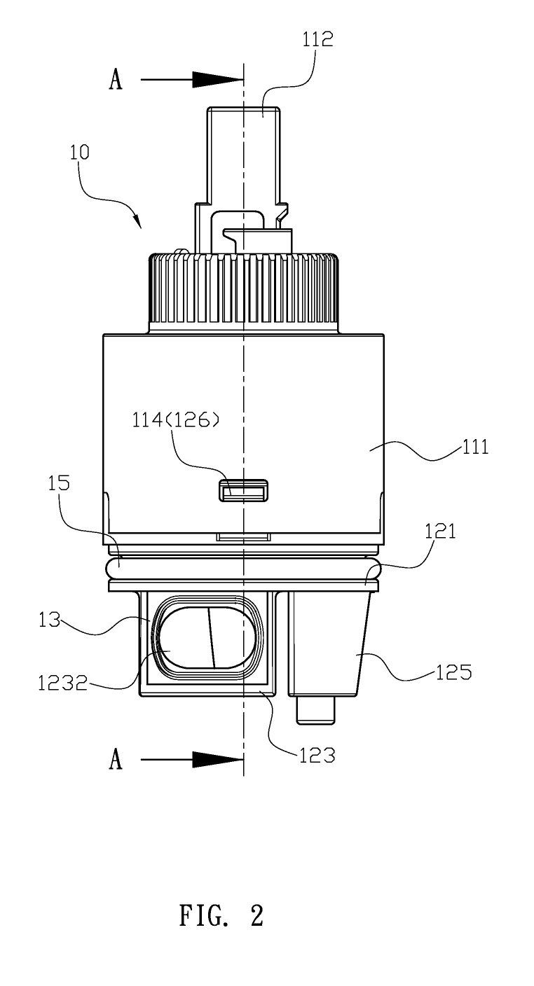

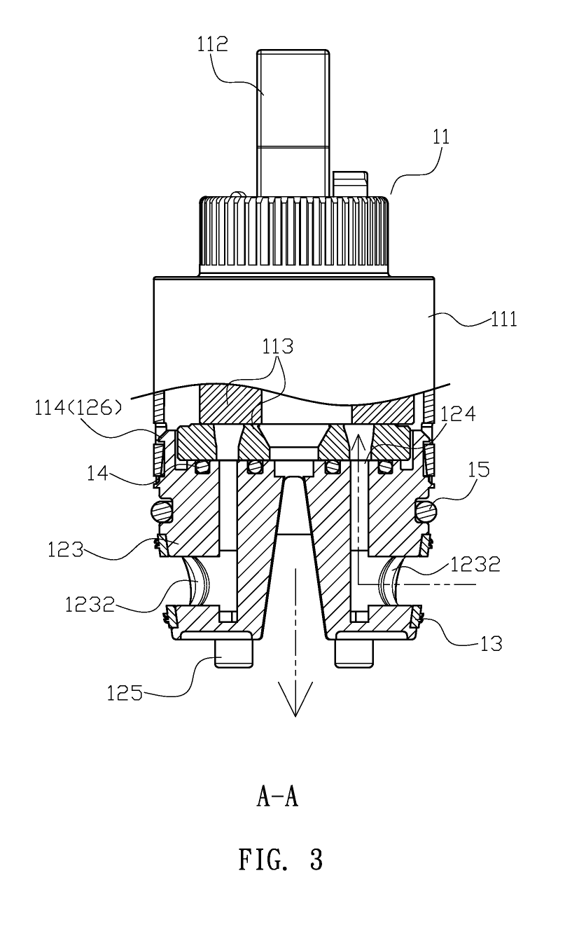

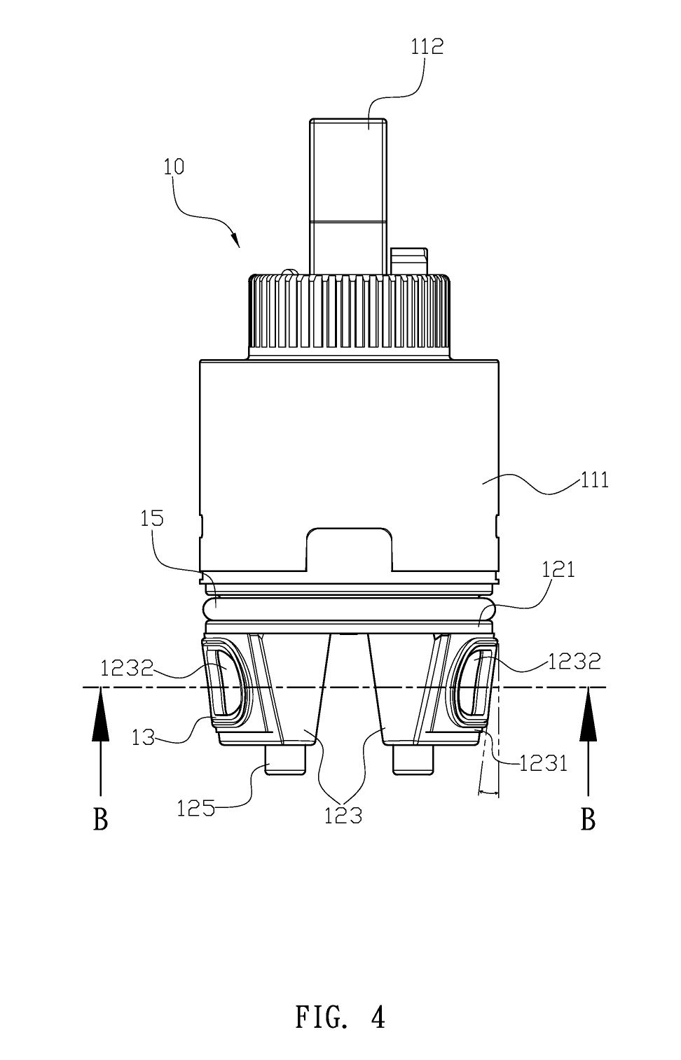

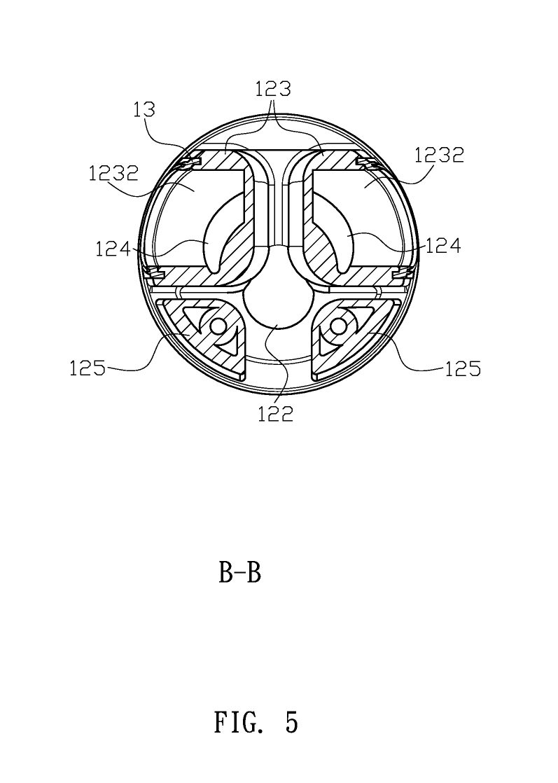

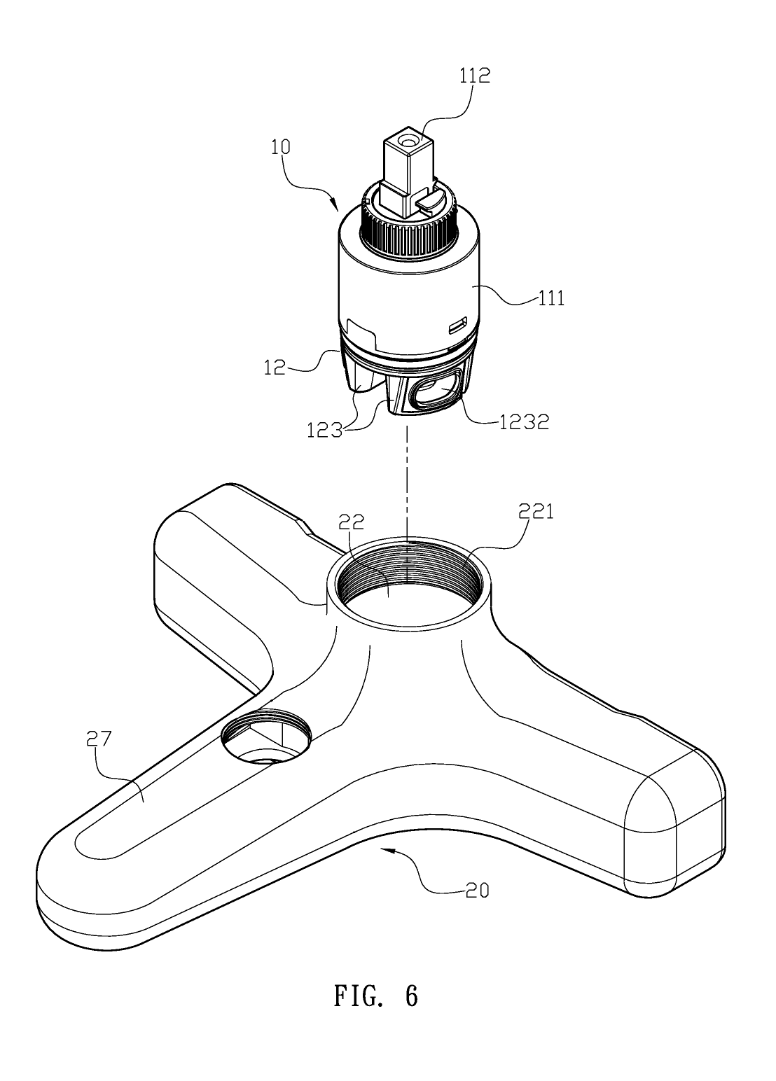

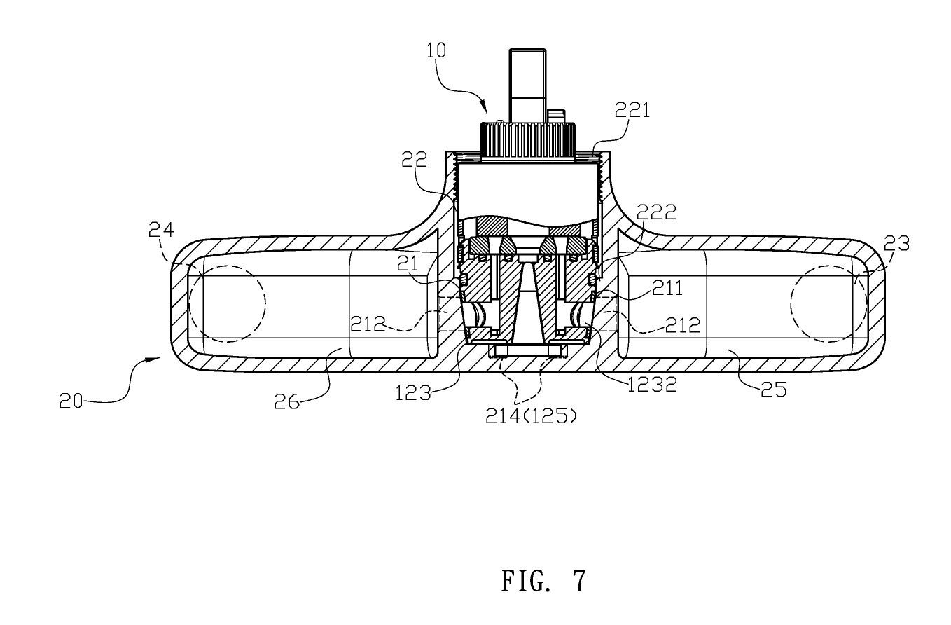

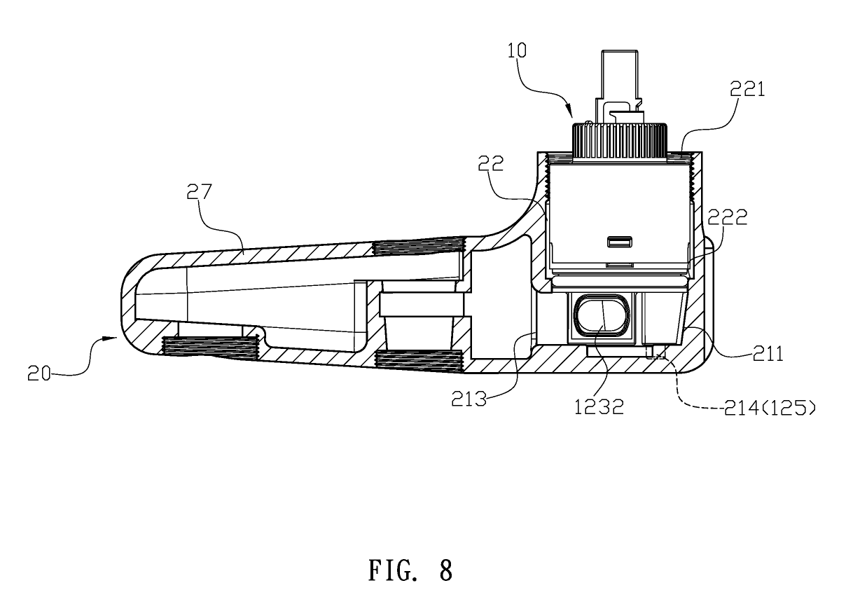

Referring to FIGS. 1 to 8, the present invention provides a structure of the control valve of faucet. This structure of the control valve (10) of faucet is carried out with the use of the faucet body (20). The control valve (10) includes a valve body (11) and valve seat (12), and the valve body (11) has a valve casting (111). There are a valve stem (112) and two pieces of valve discs (113) installed in the valve casting (111). The use of valve stem (112) provides an operating system to make two valve discs aligned or misaligned so that controlling the switch or change the mixing ration of cold water and hot water. The lower edge of valve casting (111) has a connecting hole (114) to provide the hook of valve seat (12) fix on the notch. The valve seat (12), has a roof (121), is fixed under the valve body (11). A spout (122) is set on the roof (121), and the both side edges at front of the spout have intervals and set up the inlet ducts (123) which lead water down. The lateral arcs (1231) of two inlet ducts are designed as arc which narrows down to the tapered shape. The both bottoms are all closed. Also the upper sides of two inlet ducts (123) connect with a roof (121) and the relative position on roof of each duct has a limber hole (124) to let water down into the inlet ducts (123). The two inlet ducts are used an entry which penetrate the lateral arc (1231) to let each cold and hot water through into the ducts. The outside of cold and hot water inlets (1232) set annular pad (13) to cover the ducts. The two intervals, which locate on the backsides of outlet, each extend downward a ladder-shaped positioning pin (125) respectively. The faucet body (10) is formed integrally and the internal of body set up the division chamber (21) and control valve chamber (22) which are connect up and down with each other. The division chamber (21) include a tapered inwall (211) which narrows from up to down. Above the control valve chamber (22) has an opening (221) for penetration, the bottom of control valve chamber is connected to the division chamber (21) by stepped convex ring (222). The both edges of backside of the faucet body (20) have cold water inlet (23) and hot water inlet (24). The cold water inlet connects with the cold water inlet duct (25) which is on the one internal side of the faucet body (20) and the hot water inlet connects with hot water inlet duct (26) which is on the other internal side of the faucet body (20). The two inlet ducts directly connect to the horizontal perforations (212) of division chamber (21) respectively. By connecting the outlet duct (27) of the faucet body (20) to the front outlet (213) of the division chamber (21), the cold water and hot water not only can flow individually but also can be mixed when they flow through the outlet duct (27) and come out from outlet. The bottom of division chamber (21) has limit holes (214) for helping the positioning pins (125) of control valve (10) fix on division chamber.

The present invention provides the structure of the control valve of faucet. In the control valve structure, there is a roof which extend a clutch (126). The clutch can hook on the connecting hole (114) of valve body (11) to connect each other.

The present invention provides the structure of the control valve of faucet. In the control valve structure, the relative positions of the spout (122) and limber holes on the roof (121) all inlay sealing collars on them.

The present invention provides the structure of the control valve of faucet. In the control valve structure, the periphery of the roof (121) inlays an O-ring (15). When the control valve (10) from the opening is put into the control valve compartment (22), the O-ring is tightly sealed on stepped convex ring (222). Besides, the valve seat (12) is set into tapered inwall (211) through the lateral arcs (1231). By contacting tightly between annular pad (13) and tapered inwall (211), the cold and hot water inlets (1232) and division chamber (21) will be connected perfectly.

The present invention provides the structure of the control valve of faucet. In the control valve structure, the positioning pins (125) also have a lateral arcs which narrows asymptotically from top to bottom.

The present invention provides the structure of the control valve of faucet. In the control valve structure, the periphery of cold and hot water inlet (1232) is slight caved, so that it can be attached by the annular pad (13).

The present invention provides the structure of the control valve of faucet. In the control valve structure, the lateral arc (1231) of inlet ducts (123) is set a vertical positioning groove (1233). The inner face of annular pad is set a finned spacer (131), which assembles with the positioning groove (1233), so that the annular pad (13) can resist the impact of water flow.

The present invention provides the structure of the control valve of faucet. In the control valve structure, the cold and hot water inlets (1232) of inlet ducts are deviated forward from the central axis of control seat (12).

The present invention provides the structure of the control valve of faucet. In the control valve structure, the central bottom of inlet ducts (123) set a concave part. This concave part can reduce the contact area between the bottom of division chamber (21) and inlet ducts. The invention can prevent the problem of the irregular local surfaces, which can lead to the skewed control valve, and control valve (10) cannot connect to division chamber (21) perfectly.

The present invention provides the structure of the control valve of faucet. In the control valve structure, the each central bottom of positioning pins (125) has a concave.

The present invention provides the structure of the control valve of faucet. In the control valve structure, the opening (221) of the control valve compartment (22) has a thread segment. This segment can generate the bearing pressure on control valve (10) by knot of lock ring after putting the control valve (10) into the control valve compartment (22). By co-ordination between the tapered inwall (211) and the lateral arc (1231), the lock ring can be much closer to the annular pad (13) on the surface of valve seat (12) and connect to division chamber (21) perfectly when the knot of lock ring locks are downward. When whole the valve seat (12) imbeds to the division chamber (21), the cold water inlet and hot water inlet on the valve seat can precisely aligned with the horizontal perforations (212).

In actual application, the supply of cold and hot water is from cold water inlet (23) and hot water inlet (24) into cold water inlet duct (25) and hot water inlet duct (26). Through horizontal perforations (212), the cold and hot water can be sent directly from cold and hot water inlet (1232) into control valve (10). By operating the valve stem (112) of control valve (10), the cold and hot water can flow from inlet duct (123) through limber hole (124) to the valve body (11). The cold and hot water can be used individually, or two kind of water can be mixed before they flow out. By connecting outlet (213) to the flow duct which is the interval between cold water duct and hot water duct, the water flow can come out from the outlet duct (27) successfully.

Comparing with conventional faucet control valves, the present invention is advantageous because: (i) by installing the inlet ducts (123) combine with the cold and hot water inlets (1232) which are penetrated horizontally, the structure of the control valve of faucet can separate cold water and hot water in the faucet body (20) without installing the vertical partitions. This invention can simplify the complexity of the internal flow channel, so that the faucet body (20) can be easier to manufacture and has significantly improved the yield of casting; (ii) the design of letting water horizontally penetrate through cold and hot water inlet (1232) can lead two kind of water into control valve (10) without passing the multi-stage bending segments. This invention can effectively reduce water flow noise during the water transport and make cold and hot water flow more smoothly; and (iii) the design of tapered lateral arc can make control valve (10) more fit with division chamber (21) when put control valve into division chamber. This invention can successful prevent leak of water and make the system becomes more reliable.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A control valve, which is adapted to use with a faucet, comprising a valve body and a valve seat, said valve body having a valve casting, and a valve stem and two pieces of valve discs disposed in said valve casting, wherein the valve stem is used to align or stagger two valve discs aligned so as to control a mixing ration of cold water and hot water; the valve seat fixed at a bottom of the valve body, and having a roof with a spout thereon, front edges of which having intervals and inlet ducts which lead water down, wherein lateral arcs of two inlet ducts are designed to taper the inlet ducts and the bottoms are all closed, and upper portions of said two inlet ducts connect with the roof and each inlet duct has a limber hole to direct water down into the inlet ducts, wherein the two inlet ducts penetrate the lateral arc with cold and hot water flow, and an annular pad outside cold and hot water inlets is used to cover the periphery of the cold and hot water flow.

2. The control valve of claim 1, wherein a lower edge of the valve casting has a connecting hole, and the roof has a clutch to engage with the connecting hole.

3. The control valve of claim 1, wherein a gasket is disposed on the spout and limber holes on the roof.

4. The control valve of claim 1, wherein an 0-ring is disposed at an outer periphery of the roof.

5. The control valve of claim 1, wherein a periphery of cold and hot water inlet is slightly recessed to receive an annular pad.

6. The control valve of claim 1, wherein the inner face of annular pad has a finned spacer, which assembles with the positioning groove, so that the annular pad is adapted to resist the impact of water flow.

7. The control valve of claim 1, wherein the cold and hot water inlets of inlet ducts are deviated forward from the central axis of the valve seat.

8. The control valve of claim 1, wherein a central bottom portion of the inlet duct has a recessed portion.

9. The control valve of claim 1, wherein each of the two intervals located on the backsides of outlet a positioning pin extending downward respectively.

10. The control valve of claim 9, wherein the positioning pins are ladder-shaped.

11. The control valve of claim 9, wherein the positioning pins have a lateral arcs which narrows asymptotically from top to bottom.

12. The control valve of claim 9, wherein a central bottom portion of each positioning pins has a pin recessed portion.
